(19) United States
(12) Patent Application Publication
(10) Pub. No.: US 2012/0123620 A1
(43) Pub. Date: May 17, 2012

(54) PURGING DEVICE AND METHOD FOR IMPROVING COLD-STARTABILITY OF FUEL CELL

(75) Inventors: Jae Jun Ko, Gunpo (KR); Young Min Kim, Suwon (KR); Se Joon Im, Yongin (KR); Jong Hyun Lee, Yongin (KR)

(73) Assignee: HYUNDAI MOTOR COMPANY, Seoul (KR)

(21) Appl. No.: 13/110,567

(22) Filed: May 18, 2011

(30) Foreign Application Priority Data
Nov. 17, 2010 (KR) 10-2010-0114511

(51) Int. Cl. B60L 15/00; B60L 11/18; H01M 8/04

(52) U.S. Cl. 701/22; 429/429

(57) ABSTRACT

The present invention provides a purging device and method for improving cold start performance of a fuel cell by direct heating, in which a gas mixture of hydrogen and air is supplied to a cathode of a fuel cell stack after shutdown of a fuel cell system to generate heat by a reaction of hydrogen and air, and the generated heat is used to increase the temperature of the fuel cell stack and, at the same time, remove water from the fuel cell stack.

### CROSS-REFERENCE TO RELATED APPLICATION

This application claims under 35 U.S.C. §119(a) the benefit of Korean Patent Application No. 10-2010-0114511 filed Nov. 17, 2010, the entire contents of which are incorporated herein by reference.

### BACKGROUND

(a) Technical Field

The present invention relates to a purging device and method for improving cold start performance of a fuel cell by direct heating. More particularly, it relates to a purging device and method for improving cold start performance of a fuel cell by direct heating, in which a gas mixture of hydrogen and air is supplied to a cathode of a fuel cell stack after shutdown of a fuel cell system in order to generate heat via a reaction of hydrogen and air. The generated heat then is used to increase the temperature of the fuel cell stack and, at the same time, remove water from the fuel cell stack.

(b) Background Art

A fuel cell is a device that produces heat and electrical energy as a result of a reaction which converts chemical energy directly into electrical energy via oxidation and reduction reactions of reactant gases (hydrogen and oxygen in air) continuously supplied to a fuel cell stack which has a plurality of unit cells stacked together.

The electrical generation a fuel cell stack occurs via the following method. When the reactant gases (hydrogen and oxygen in air) are supplied to each unit cell through an inlet manifold of the fuel cell stack, an oxidation reaction of hydrogen occurs at an anode, and thus hydrogen ions (protons, H+) and electrons (e−) are produced. The hydrogen ions and electrons are transmitted to a cathode through an electrolyte membrane and a separator, respectively. At the cathode, water is produced by an electrochemical reaction between the hydrogen ions and electrons transmitted from the anode and the oxygen in the air. Electrical energy generated by the flow of the electrons is supplied to a load requiring the electrical energy through a current collector of an end plate.

Meanwhile, each unit cell of the fuel cell stack has a membrane electrode assembly (MEA) including a polymer electrolyte membrane, a cathode as an air electrode, and an anode as a fuel electrode, the cathode and the anode being disposed on each of both sides of the polymer electrolyte membrane, a gas diffusion layer (GDL) stacked on the outside of the cathode and the anode, a gasket, a sealing member, and a bipolar plate (BP).

Here, the ion conductivity of the polymer electrolyte membrane increases as the hydration state of the electrolyte membrane is higher. Therefore, a hydrogen recirculation system is applied to a hydrogen supply system and a humidifier for humidifying air is applied to an air supply system, thereby facilitating the hydration of the electrolyte membrane during operation of the fuel cell system.

However, water in the humidified air supplied to the fuel cell stack and water generated by the reaction in the fuel cell stack freeze when the temperature of the fuel cell system drops below 0 degrees Celsius. The volume expansion when the water freezes into ice may cause damage to the MEA having a porous structure and the GDL.

Moreover, during cold start of the fuel cell, the product water is still present in the form of ice in the electrodes such as the anode and the cathode and is not discharged before thawing, and thus the volume expansion when the water freezes into ice blocks the transfer path of reactant gases such as hydrogen and oxygen in the air.

Therefore, in order to improve the cold start performance in winter when the outside temperature is below 0 degrees Celsius, it is necessary to remove water from the fuel cell stack before the fuel cell system is shut down, and thus various methods for removing the water from the fuel cell stack during shutdown have been proposed. For example, these methods include a method of using dry nitrogen gas, a method of supplying dry gas using a bypass line, a method of removing water by depressurization, a method of removing water by pulse purging, etc.

However, when the system uses dry nitrogen gas, a separate nitrogen tank must be provided in a vehicle, thus, adding unnecessary weight and taking up precious space. Furthermore, when a system is used which uses dry gas which is supplied via the bypass line, a bypass pipe having a large diameter and a valve must be used, and the valve must controlled. Moreover, when the water is removed by depressurization, a vacuum pump for depressurization is separately required. Furthermore, when the water is removed by pulse purging, such purging can only be applied to the anode for hydrogen purging, a separate valve is required for the cathode, and it takes quite a long time to complete the purging process.

Therefore, in order to improve the cold start performance, a method for removing a larger amount of water from the fuel cell stack, minimizing the shutdown time, and maximizing the cold start performance is required.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a purging device and method for improving cold start performance of a fuel cell via direct heating, in which a purge process of supplying a gas mixture of hydrogen and air to a cathode of a fuel cell stack is performed after shutdown of a fuel cell system to generate heat by a reaction of hydrogen and air. The generated heat is used to increase the temperature of the fuel cell stack such that the removal of water from the cathode via purging of the gas mixture and the removal of water from an anode by hydrogen purging can be completed at the same time. Moreover, as the temperature of the fuel cell stack increases during the purge process, water is effectively removed from the stack by purging and increasing the temperature of the fuel cell stack at the same time.

In one aspect, the present invention provides a purging device for improving cold start performance of a fuel cell by direct heating. In particular, the device includes a fuel cell stack having an anode and a cathode; a first valve provided in a hydrogen supply line for supplying hydrogen to the anode; a second valve provided in a hydrogen discharge line connected to an outlet of the anode; a branch line connected between a line, which connects the first valve in the hydrogen supply line and the anode, and an air supply line for supplying air to the cathode; a third valve provided in the branch line; and a controller for controlling the opening and closing of the first to third valves.

In an illustrative embodiment, the purging device may have a temperature sensor to provided in an air discharge line connected to an outlet of the cathode of the fuel cell stack.

In another embodiment, the first valve may be opened in response to a signal from the controller during operation and purging of the fuel cell stack.

In still another embodiment, the second valve may be periodically opened during operation of the fuel cell stack, closed when hydrogen and air are supplied during purging after shutdown, and periodically opened when an exothermic reaction occurs at the cathode.

In yet another embodiment, the third valve is closed during operation of the fuel cell stack and opened when hydrogen and air are supplied to the cathode during purging after shutdown.

In another aspect, the present invention provides a purging method for improving cold start performance of a fuel cell via direct heating. In particular, the method first supplies a gas mixture of hydrogen and air to a cathode of a fuel cell stack after shutdown of the fuel cell stack; allows an electrochemical reaction of hydrogen and air to occur at the cathode of the fuel cell stack to generate heat and increase the temperature of the fuel cell stack; and purge the gas mixture after the completion of the reaction from the cathode and, at the same time, allows water to be removed from the cathode.

In an illustrative embodiment, when supplying the gas mixture, a first valve provided in a hydrogen supply line and a third valve connected between the hydrogen supply line and an air supply line are opened to supply the gas mixture of hydrogen and air to the cathode of the fuel cell stack.

In another embodiment, the purging may also include periodically opening a second valve provided in a hydrogen discharge line connected to an outlet of an anode of the fuel cell stack so that the hydrogen is periodically purged from the anode.

In still another embodiment, when the temperature of the gas mixture purged from the cathode reaches a predetermined reference temperature, the supply of air may be cut off and the first and third valves may be closed to cut off the supply of hydrogen.

In yet another embodiment, the removal of water when the mixed gas is purged from the cathode and the removal of water by the generated heat occur at the same time.

Other aspects and embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing the configuration of a purging device for improving cold start performance of a fuel cell by direct heating in accordance with an exemplary embodiment of the present invention.

FIG. 2 is a flowchart showing a purging method for improving cold start performance of a fuel cell by direct heating in accordance with another exemplary embodiment of the present invention.

FIG. 3 is a schematic diagram showing the results of an electrochemical reaction to during purging of a fuel cell by direct heating in accordance with an illustrative embodiment of the present invention and that during normal operation.

FIG. 4 is a graph showing the test results of a purging device for improving cold start performance of a fuel cell by direct heating in accordance with an exemplary embodiment of the present invention, in which a change in temperature of a fuel cell stack when hydrogen and air are supplied to a cathode is shown.

FIG. 5 is a graph showing a change in cell voltage of a fuel cell stack due to a change in open circuit voltage of the fuel cell stack.

Reference numerals set forth in the Drawings includes reference to the following elements as further discussed below:

10: fuel cell stack

12: anode

14: cathode

20: hydrogen supply line

22: hydrogen discharge line

24: air supply line

26: branch line

28: air discharge line

31: first valve

32: second valve

33: third valve

34: temperature sensor

40: controller

42: air blower

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used to herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

As mentioned above, in order to improve cold start performance in winter when the outside temperatures are below zero degrees Celsius, it is necessary to remove water from a fuel cell stack before a fuel cell system is shut down, and thus various purging methods for removing residual water from the fuel cell system have been applied.

For example, after shutdown of the fuel cell system, the removal of water from the fuel cell stack is significantly affected by the method of discharging gas (air) from an air electrode, to which a relatively large amount of gas is supplied, the amount of gas discharged, the temperature of a gas outlet, etc. Therefore, the increase in the temperature of the fuel cell stack, i.e., the increase in the temperature of the gas outlet under various test conditions, is an important factor in cold start performance. This is because when the temperature of gas discharged from the fuel cell stack is high, the saturated vapor pressure is lowered, thus increasing the amount of water removed from the fuel cell stack.

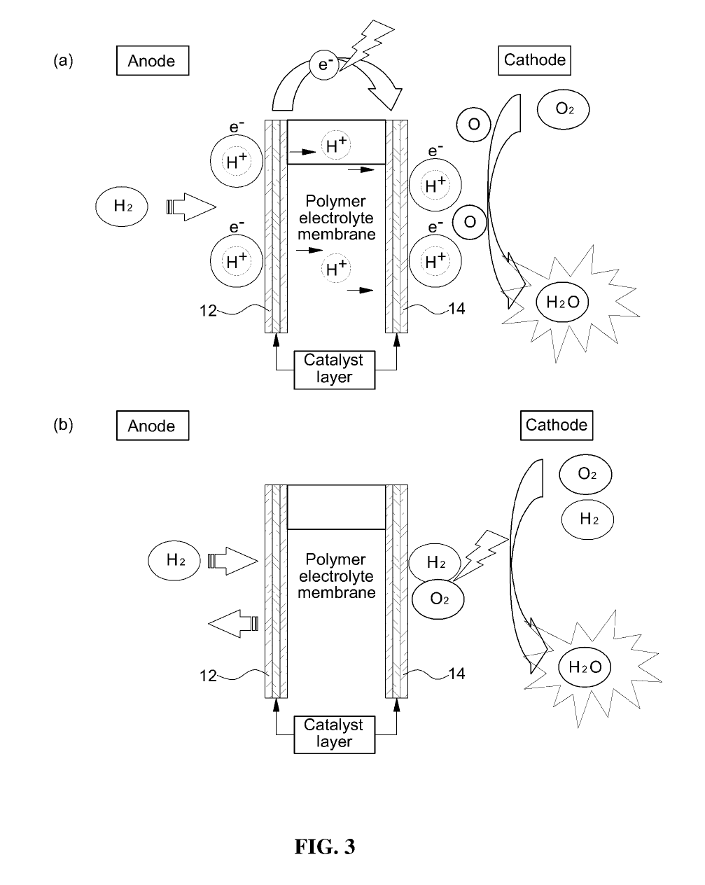

The present invention provides a method of maximizing the cold start performance of the fuel cell by supplying a gas mixture of hydrogen and air to the cathode of the fuel cell stack to increase the effect of water removal after shutdown of the fuel cell system so that electricity, water, and heat are produced by an electrochemical reaction of the mixed gas at the cathode (refer to FIG. 3b), thereby increasing the temperature of the fuel cell stack and purging the gas mixture from the fuel cell stack, unlike an electrochemical reaction which occurs during normal operation (refer to FIG. 3a).

For this purpose, a first valve 31 is provided in a hydrogen supply line 20 connected to an inlet of an anode 12 of a fuel cell stack 10, and a second valve 32 is provided in a hydrogen discharge line 22 connected to an outlet of the anode 12.

Moreover, a branch line 26 is connected between the hydrogen supply line 20, which connects the first valve 31 and the anode 12, and an air supply line 24 for supplying air to a cathode 14, and a third valve 33 is provided in the branch line 26. Here, the opening and closing of the first to third valves 31, 32 and 33 is controlled by a controller 40 for controlling the overall fuel cell system.

A temperature sensor 34 measures the temperature of gas discharged and transmits a signal to the controller 40. The temperature sensor 34 is disposed in an air discharge line 28 connected to an outlet of the cathode 14 of the fuel cell stack 10.

The opening and closing of the first to third valves 31, 32 and 33 are controlled by the controller 40 during normal operation of the fuel cell stack 10 and during purging such as shutdown. The first valve 31 is opened in response to a signal from the controller 40 during operation and purging of the fuel cell stack 10. The second valve 32 is periodically opened to during operation of the fuel cell stack 10, closed when the mixed gas of hydrogen and air is supplied, and periodically opened when an exothermic reaction of the mixed gas occurs at the cathode 14. The third valve 33 is closed during operation of the fuel cell stack 10 and opened when hydrogen is supplied to the cathode 14 during purging after shutdown.

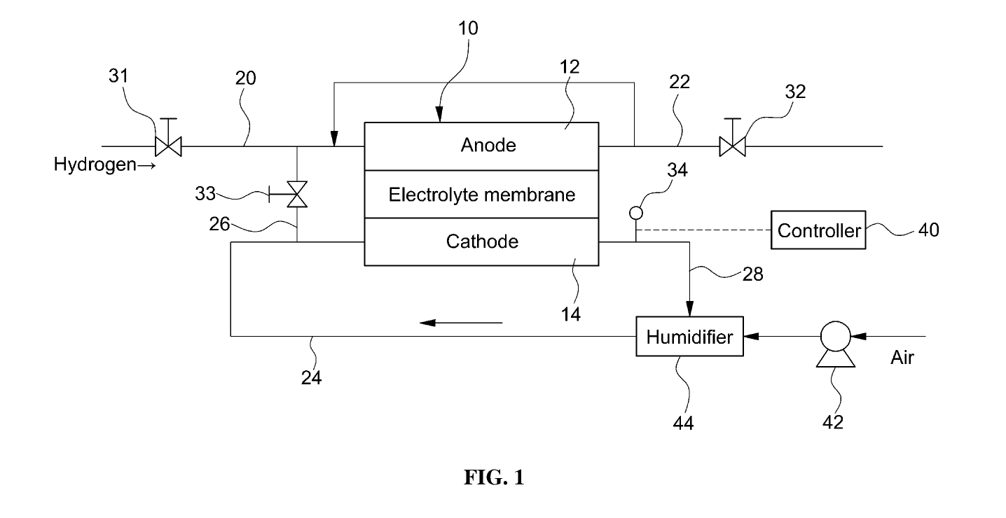

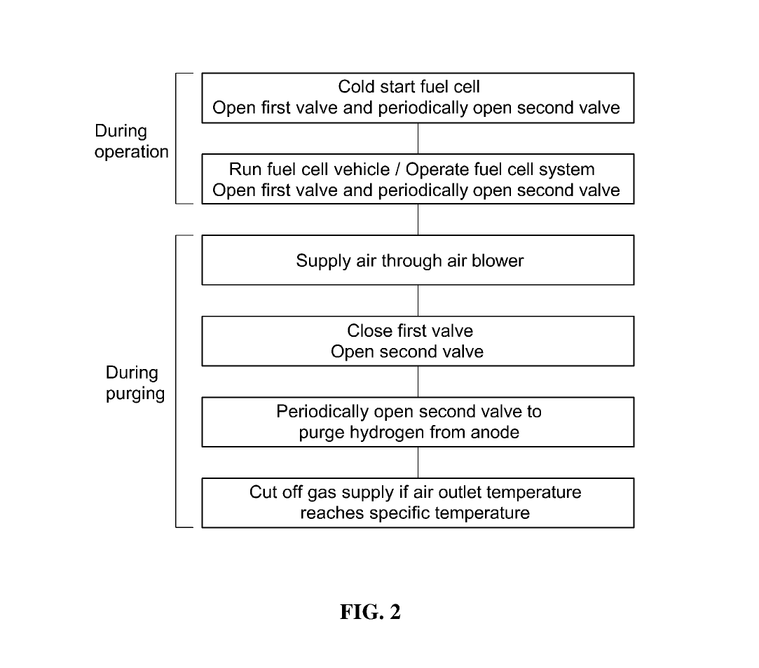

Furthermore, the illustrative embodiment of the present invention also provides a purging method for improving cold start performance of a fuel cell by direct heating, performed by controlling the opening and closing of the first to third valves will be described in more detail with reference to FIGS. 1 and 2.

First, during cold start of the fuel cell system or during normal operation, air is supplied by blowing device, e.g., an air blower 42, humidified by a humidifying device, e.g., a humidifier 44, and then supplied to the cathode 14 of the fuel cell stack 10 through the air supply line 24. At the same time, hydrogen is supplied to the anode 12 of the fuel cell stack 10 as the first valve 31 of the hydrogen supply line 20 is opened such that hydrogen purging is performed as the second valve 32 of the hydrogen discharge line 22 is periodically opened.

After shutdown of the fuel cell stack 10, a process of supplying the gas mixture of hydrogen and air to the cathode 14 of the fuel cell stack 10 is performed. That is, the first valve 31 of the hydrogen supply line 20 is opened and, at the same time, the third valve 33 disposed between the hydrogen supply line 20 and the air supply line 24 is opened such that the air supplied through the air supply line 24 and the hydrogen supplied through the third valve 33 are mixed and supplied to the cathode 14 of the fuel cell stack 10. Here, the hydrogen passing through the first valve 31 of the hydrogen supply line 20 is supplied to the cathode 14 through the third valve 33 together with the air, and the hydrogen is partially supplied to the anode 12 of the fuel cell stack 10.

Subsequently, a electrochemical reaction of the gas mixture of hydrogen and air supplied to the cathode 14 of the fuel cell stack 10 occurs at the cathode 14 (refer to FIG. 3b) to produce electricity, water, and heat, and the temperate of the fuel cell stack 10 is increased by the produced heat.

Then, the gas mixture resulting from the reaction is purged from the cathode 14 while at the same time, removing the water from the cathode. In more detail, water is removed via the pressure created when the gas mixture is purged from the cathode 14 and the also by heat generation at the same time.

While the gas mixture resulting from the reaction is purged during the exothermic reaction at the cathode, the temperature of the fuel cell stack increases, and thus it is possible to remove water both by purging of the gas mixture (i.e., via pressure) and by increasing the temperature of the fuel cell stack (i.e., through evaporation) at the same time. Especially, when the fuel cell system is shut down at low temperature, e.g., when the purging effect is insignificant as the temperature is low, the effect of water removal can be maximized.

Moreover, since the hydrogen is partially supplied to the anode 12 of the fuel cell stack, the second valve 32 of the hydrogen discharge line 22 connected to the outlet of the anode 12 is periodically opened such that the hydrogen is periodically purged from the anode 12, thereby removing the water present in the anode 12 together with the purged hydrogen.

The temperature sensor 34 measures the temperature of the gas mixture purged from the cathode 14, i.e., the temperature of the gas outlet of the cathode 14, and transmits a signal to the controller 40. Then, if it is determined that the temperature of the gas outlet reaches a predetermined reference temperature, the controller 40 stops the operation of the air blower 42 to cut off the supply of air and, at the same time, closes the first and third valves 31 and 33 to cut off the supply of hydrogen.

For instance, in a test example of the present invention, the mixed gas of hydrogen and air was supplied to the cathode of the fuel cell stack during shutdown, and the amount of heat generated was measured. The temperature of the fuel cell stack was measured (based on the temperature of the gas outlet) when the amount of hydrogen supplied was 7% with respect to the amount of air supplied.

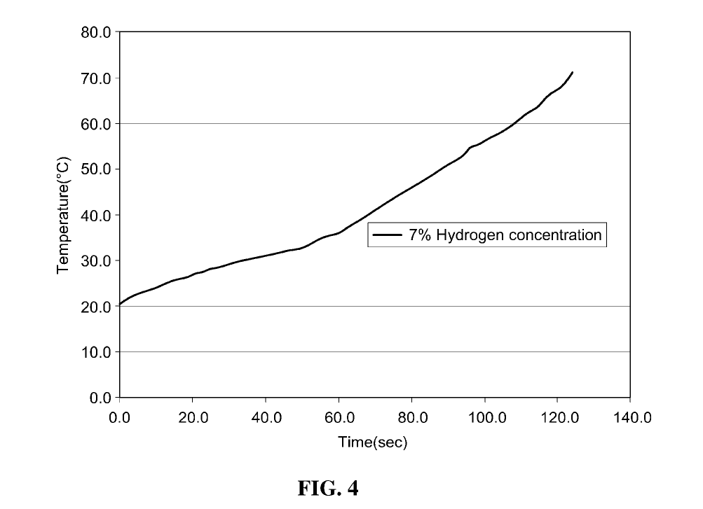

That is, the temperature of the gas outlet of the cathode was measured after supplying the hydrogen at a flow rate of 8.4 lpm with respect to the air flow rate of 120 lpm. As shown in FIG. 4, it can be seen that the temperature of the fuel cell stack increased at a rate of 0.42° C./sec.

Comparing the temperature increase rate of the fuel cell stack according to the present invention to that of the fuel cell stack using an existing resistor (in which the temperature increases at a rate of 0.5° C./sec at 100 A and at a rate of 0.25° C./sec at 50 A), it can be seen that the present invention provides an exothermic effect of about 80 A or higher.

In another test example of the present invention, the open circuit voltage (OCV) generated when the gas mixture of hydrogen and air was purged was measured. That is, the change in the OCV with respect to the change in concentration of hydrogen in the air was measured, and the results are shown in the following Table 1:

TABLE 1

| Hydrogen concentration | Change in OCV |
|---|---|
| 0 | 1.023 V |
| 2 | 0.908 V |
| 3 | 0.883 V |
| 5 | 0.891 V |
| 7 | 0.861 V |
| 10 | 0.848 V |

As shown in Table 1, the higher the concentration of hydrogen at the cathode, the lower the OCV. Moreover, when hydrogen of 7 vol % with respect to air was supplied to the cathode and purged, a voltage drop of about 0.15 V was realized.

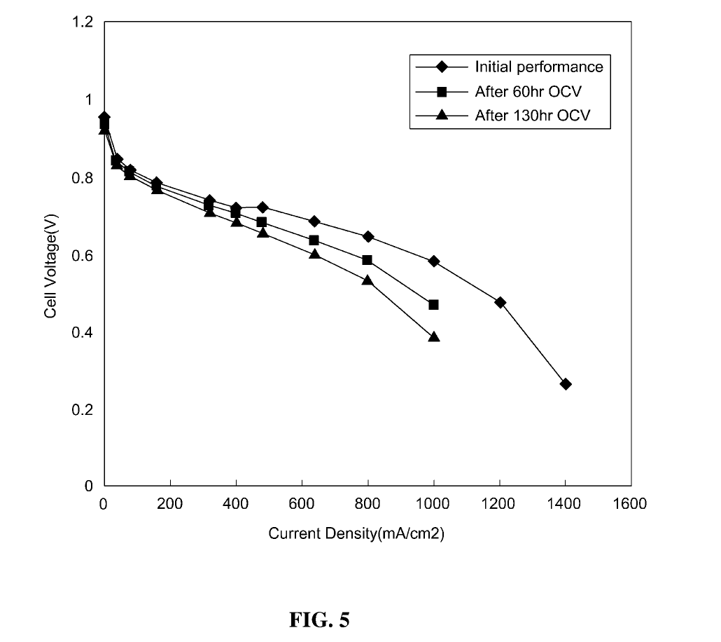

As shown in the graph of FIG. 5, when the state of OCV was maintained for a longer period of time (at a high potential of 0.9 V or higher), the cell voltage was reduced, which might deteriorate the performance of the fuel cell. Therefore, minimizing the exposure time at OCV is important factor in improving the durability of the fuel cell stack.

As such, the OCV was reduced after the hydrogen was supplied to the cathode during purging, and as a result of evaluating the durability, the performance was improved about 3.2 times.

Advantageously, during purging after shutdown of the fuel cell stack, a gas mixture of hydrogen and air is supplied to the cathode of the fuel cell stack so that the electrochemical reaction of hydrogen and air occurs at the cathode to generate heat and increase the temperature of the fuel cell stack. Therefore, water is removed when the gas mixture is purged from the cathode. Additionally water is also removed by the generation of heat at the same time, thereby facilitating the removal of water from the fuel cell stack after to shutdown before cold start.

More specifically, when the fuel cell stack is shut down at low temperature, i.e., when the purging effect is insignificant as the temperature is low, the effect of water removal can be maximized.

Moreover, during purging, the temperature of the fuel cell stack is increased by the heat generated at the cathode, and thus it is possible to achieve the effect of water removal by purging of the gas mixture and the effect of water removal by an increase in temperature of the fuel cell stack at the same time.

Furthermore, conventionally, when the fuel cell stack is shut down at low temperatures, a separate resistor is used to increase the temperature of the fuel cell stack, i.e., to extract current flow from the fuel cell stack. However, the present invention does not require such a resistor or a bypass line to remove water from the cathode, which is advantageous in terms of installation cost.

In addition, the OCV of the fuel cell stack is reduced when the hydrogen is supplied to the cathode during purging, and thus the durability performance of the fuel cell stack is improved.

Furthermore, the control mechanisms of the present invention may be embodied as computer readable media on a computer readable medium containing executable program instructions executed by a processor. Examples of the computer readable mediums include, but are not limited to, ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A purging device for improving cold start performance of a fuel cell by direct heating, the device comprising:
a fuel cell stack including an anode and a cathode;
a first valve provided in a hydrogen supply line for supplying hydrogen to the anode;
a second valve provided in a hydrogen discharge line connected to an outlet of the anode;
a branch line connected between a line, which connects the first valve in the hydrogen supply line and the anode, and an air supply line for supplying air to the cathode;
a third valve provided in the branch line; and
a controller for controlling the opening and closing of the first, second and third valves.

2. The purging device of claim 1, further comprising a temperature sensor disposed in an air discharge line connected to an outlet of the cathode of the fuel cell stack.

3. The purging device of claim 1, wherein the first valve is opened in response to a signal from the controller during operation and purging of the fuel cell stack.

4. The purging device of claim 1, wherein the second valve is periodically opened during operation of the fuel cell stack, closed when hydrogen and air are supplied during purging after shutdown, and periodically opened when an exothermic reaction occurs at the cathode.

5. The purging device of claim 1, wherein the third valve is closed during operation of the fuel cell stack and opened when hydrogen and air are supplied to the cathode during purging after shutdown.

6. A purging method for improving cold start performance of a fuel cell by direct heating, the method comprising:
supplying a gas mixture of hydrogen and air to a cathode of a fuel cell stack after shutdown of the fuel cell stack;
allowing an electrochemical reaction of hydrogen and air to occur at the cathode of the fuel cell stack to generate heat and increasing the temperature of the fuel cell stack; and
purging the gas mixture after the reaction from the cathode and, at the same time, allowing water to be removed from the cathode.

7. The purging method of claim 6, wherein in supplying the gas mixture, a first valve provided in a hydrogen supply line and a third valve connected between the hydrogen supply line and an air supply line are opened to supply the gas mixture of hydrogen and air to the cathode of the fuel cell stack.

8. The purging method of claim 6, further comprising periodically opening a second valve provided in a hydrogen discharge line connected to an outlet of an anode of the fuel cell stack such that the hydrogen is periodically purged from the anode.

9. The purging method of claim 6, wherein when the temperature of the gas mixture purged from the cathode reaches a predetermined reference temperature, the supply of air is cut off and the first and third valves are closed to cut off the supply of hydrogen.

10. The purging method of claim 6, wherein the removal of water when the gas mixture is purged from the cathode and the removal of water by the generated heat occur at the same time.

11. A non-transitory computer readable medium containing executable program instructions executed by a processor to control a purging process in a fuel cell stack of a vehicle, comprising:
program instructions that control the supply of a gas mixture of hydrogen and air to a cathode of a fuel cell stack after shutdown of the fuel cell stack wherein an electrochemical reaction of hydrogen and air to occurs at the cathode of the fuel cell stack to generate heat and increasing the temperature of the fuel cell stack; and
program instructions that control the purging the gas mixture after the completion of the reaction from the cathode and, at the same time, allows water to be removed from the cathode.

12. The non-transitory computer readable medium of claim 11, wherein in controlling the supply of the gas mixture, a first valve provided in a hydrogen supply line and a third valve connected between the hydrogen supply line and an air supply line are opened to supply the gas mixture of hydrogen and air to the cathode of the fuel cell stack.

13. The non-transitory computer readable medium of claim 11, further comprising program instructions that periodically open a second valve provided in a hydrogen discharge line connected to an outlet of an anode of the fuel cell stack such that the hydrogen is periodically purged from the anode.

14. The non-transitory computer readable medium of claim 11, wherein when the temperature of the gas mixture purged from the cathode reaches a predetermined reference temperature, the supply of air is controlled to cut off and the first and third valves are controlled to close to cut off the supply of hydrogen.

15. The non-transitory computer readable medium of claim 11, wherein the removal of water when the gas mixture is purged from the cathode and the removal of water by the generated heat occur at the same time.
